(19) United States
(12) Patent Application Publication
(10) Pub. No.: US 2014/0367870 A1
(43) Pub. Date: Dec. 18, 2014

(54) CARBURETOR SPACER HAVING AN EMBEDDED FAN

(71) Applicants: George Simmons, Salem, VA (US); Christi Simmons, Salem, VA (US)

(72) Inventors: George Simmons, Salem, VA (US); Christi Simmons, Salem, VA (US)

(21) Appl. No.: 14/305,541

(22) Filed: Jun. 16, 2014

Related U.S. Application Data
(60) Provisional application No. 61/835,407, filed on Jun. 14, 2013.

(51) Int. Cl. F02M 17/16

(52) U.S. Cl. CPC F02M 17/16
USPC 261/36.2

(57) ABSTRACT

A modified carburetor spacer for providing greater efficiency in the operation of internal combustion engine having an attached carburetor (or “carburetor engine assembly”) comprising a conventional carburetor spacer body and a five-blade fan disposed at least one open section of said carburetor spacer body. The modified carburetor spacer can be attached underneath the carburetor of a carburetor engine assembly by means typical to the carburetor spacer installation, including through the use of two metal rods with accompanying nuts and bolts. When a carburetor engine assembly having an installed modified carburetor spacer is used, the vacuum created by the operation of the motor causes the fan blades in the modified carburetor space to spin. As the stream created by the carburetor passes through the spinning fan blades, the stream is converted to a mist before proceeding to the engine

### CROSS REFERENCE TO RELATED APPLICATIONS

This application claims the benefit of co-pending U.S. provisional patent application Ser. No. 61/835,407 filed Jun. 14, 2013.

### BACKGROUND OF THE INVENTION

1. Field of the Invention

This invention relates generally combustion engine accessories and, more particularly, to an apparatus which is used in conjunction with a carburetor to better mix fuel and increase the fuel efficiency of an engine.

2. Description of the Prior Art

The use of a carburetor to blend fuel and air in conjunction with the operation of an internal combustion engine is well known. At its core, a carburetor will typically comprise at least a tube structure, a throttle plate, a venturi and a jet to perform the basic fuel mixing functions. When connected to an internal combustion engine, a carburetor spacer is often included to separate the carburetor structure from the intake of the engine. When used, carburetor spacers typically perform the tasks of insulating the carburetor from engine heat to keep the incoming air and fuel cooler and acting as a tuning aid to produce more power.

A common problem with conventional carburetors in use with internal combustion engines is the production of a stream of gasoline by the carburetor. As such a stream does not allow the fuel to be burned to mix well in the engine, a reduction in efficiency of the motor is common result of the same. Such a reduction in efficiency of the motor will in turn cause a reduction in fuel efficiency. Although conventional carburetor spacers when in place attempt to keep the carburetor cooler, it is well known that they do not address this particular problem and substantially eliminate the presence of the stream. Thus, there remains a need for a device which can be attached to a carburetor that can eliminate the inefficiencies introduced by the production of the stream by the carburetor. It would be helpful for such a device to not require electrical or some other source of power to operate. Furthermore, for it to be practical, it would be additionally desirable for such a device to be able to be easily retrofitted in existing carburetor and engine assemblies.

The Applicant's invention described herein provides for an improved carburetor spacer design which can be used in place of a conventional carburetor spacer and that effectively converts a stream generated by the carburetor to a mist. The primary components of Applicant's improved carburetor spacer include a carburetor spacer body having a five-blade fan disposed in the open section of the carburetor spacer body. When in operation, the fan is turned automatically due to the vacuum created by the motor. By such action, the fan coverts the stream produced in the carburetor to mist to allow for better fuel mixing and improved operating efficiency of the engine.

### SUMMARY OF THE INVENTION

A modified carburetor spacer for providing greater efficiency in the operation of internal combustion engine having an attached carburetor (or “carburetor engine assembly”) by improving the air fuel mixture that is received by the engine. The modified carburetor spacer comprises a conventional carburetor spacer body and a five-blade fan disposed in at least one open section of said carburetor spacer body. The conventional carburetor spacer body provides a structural means for converting a stream of gasoline to mist and the five-blade fan provides the conversion means for converting a stream to mist. The modified carburetor spacer can be attached underneath the carburetor of a carburetor engine assembly by means typical to the carburetor spacer installation, including through the use of two metal rods with accompanying nuts and bolts.

When a carburetor engine assembly having an installed modified carburetor spacer is used, the vacuum created by the operation of the motor causes the fan blades in the modified carburetor to spin. As the stream created by the carburetor passes through the spinning fan blades, the stream is converted to a mist before proceeding to the engine. While the stream does not mix properly with the fuel, once the stream is converted to mist, the fuel is able to mix properly prior to entering the engine. It is because the mist allows for proper fuel mixing, improved operational and fuel efficiency can be obtained by through use of the modified carburetor spacer.

It is an object of this invention is to provide an improved carburetor spacer design which can be used in place of a conventional carburetor spacer to additionally convert the stream generated by the carburetor to mist.

It is another object of this invention to provide a device that is capable of operation through the forces already present in the engine assembly.

It is yet another object of this invention to provide a device to be able to be easily retrofitted in existing carburetor and engine assemblies.

These and other objects will be apparent to one of skill in the art.

### BRIEF DESCRIPTION OF THE DRAWINGS

FIG. 1 is a top plan view of a modified carburetor spacer built in accordance with the preferred embodiment of the present invention.

FIG. 2 is a side elevational view of a modified carburetor spacer built in accordance with the preferred embodiment of the present invention.

### DETAILED DESCRIPTION OF THE INVENTION

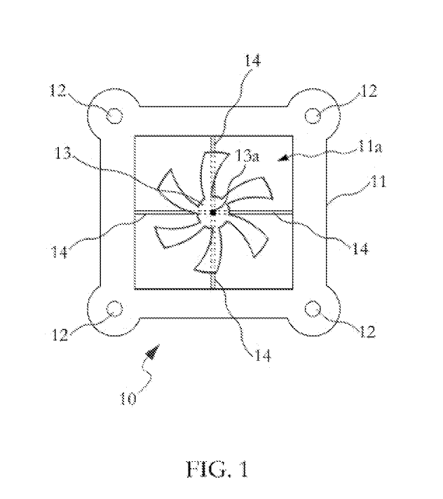

Referring now to the drawings and in particular FIG. 1, a modified carburetor space 10 built in accordance with the present invention is shown comprising of a spacer body 11, a plurality of spacer body mounts 12 and five-blade fan 13 disposed in the open section 11a of said spacer body 11 and attached to said spacer body 11 through elongated supports 14. In the preferred embodiment, the spacer body 11 is constructed out of aluminum and measures one inch thick. The fan 13 is also constructed of metal. Because of this, the preferred embodiment of the modified carburetor spacer 10 is adapted to work in temperatures up to 180 degrees Fahrenheit.

The elongated supports 14 securely attach to the spaced body 11 and to the fan 13 so as to hold the fan in place in a configuration where the blades can spin freely. As such, in the preferred embodiment the elongated supports 14 attach to the fan 13 at a center axis 13a about which the fan 13 spins so as to not at all impede the fan's 13 ability to spin in the presence of moving air.

As the fan 13 is configured to be spun by the air flow created by the vacuum in the engine when an engine assembly which includes the modified carburetor spacer 10 is in use, it is contemplated that the blades of the fan 13 are shaped and placed at a pitch which causes them to spin counter clockwise in relation to the engine intake. The shape and pitch of the fan 13 blades is also configured to push the gas passing through the modified carburetor assembly more evenly into the engine intake.

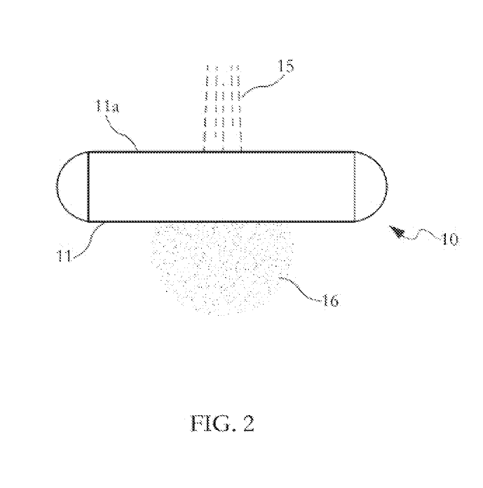

Referring now to FIG. 2, the modified carburetor spacer uses the forces already present in a typical engine assembly in order to improve the efficiency of the engine assembly. As is already well known, the normal operation of the engine creates a flow from the carburetor of the engine assembly to the engine of that engine assembly. When a conventional carburetor spacer is disposed between the carburetor and the engine, the distance created by the conventional carburetor acts to insulate the carburetor from engine heat and the one or more open spaces act to tune the air to enter the engine for one or more desired results. When the modified carburetor spacer 10 is employed in place of a conventional carburetor spacer, air flow created by the engine from the carburetor creates a vacuum which spins the blades of the fan disposed in the modified carburetor spacer 10. A gasoline stream 15, which is in the air flow exiting a carburetor, passes through the open section 11a in the spacer body 11 and thus the spinning fan blades. The spinning fan blades convert the stream 15 which entered the fan to mist 16. This mist 16 is carried by the air flow into the engine intake. Thus, by way of its conventional structure as well as its modified aspects, the modified carburetor spacer 10 converts the stream 15 exiting the carburetor to mist 16 to allow for improved fuel mixing, while still providing insulation from engine heat and allowing for tuning of air as desired.

In an alternate embodiment of the present invention, the modified carburetor spacer includes plurality of open sections having fans disposed therein.

In another alternate embodiment of the present invention, the pitch of the fan blades is used to additionally tune the air prior to entering the engine.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A modified carburetor spacer, comprising:
a carburetor spacer body, wherein said spacer body is adapted to be mounted to a carburetor in between the carburetor's output and the intake of an accompanying engine; and
at least one fan having a plurality of blades and mounted in the spacer body, wherein said at least one fan is configured to convert a fluid material passing through said spacer body into a mist.

2. The modified carburetor spacer of claim 1, wherein said fan is adapted to be spun by the air flow from said carburetor to said engine.

3. The modified carburetor spacer of claim 1, wherein said at least one fan is mounted in an open section of said carburetor spacer body.

4. The modified carburetor spacer of claim 3, wherein said at least one fan is mounted in the center of said carburetor spacer body.

5. The modified carburetor spacer of claim 1, wherein said at least one fan is defined as a five blade fan.

6. The modified carburetor spacer of claim 1, wherein the blades of said at least one fan are shaped and placed at a pitch which causes them to spin counter clockwise in relation to the engine intake.

7. A modified carburetor spacer, comprising:
a carburetor spacer body, wherein said spacer body is adapted to be mounted to a carburetor in between the carburetor's output and the intake of an accompanying engine; and
a five blade fan having a plurality of blades and mounted in the center of said spacer body, wherein said fan is adapted to be spun by the air flow from said carburetor to said engine and the blades of said fan are shaped and placed at a pitch which causes them to spin counter clockwise in relation to the engine intake.

8. A modified carburetor spacer, comprising:
a structural means for converting a stream to mist, wherein said structural means is configured to be mounted to a carburetor in between the carburetor's output and the intake of an accompanying engine; and
a conversion means disposed in said structural means for converting the stream to mist.
